(19) United States
(12) Patent Application Publication
(10) Pub. No.: US 2006/0253361 A1
(43) Pub. Date: Nov. 9, 2006

(54) Method for providing total return swaps using a dealer hedging facility

(76) Inventors: Mark I. Robinson, New York, NY (US); E. Russell Ives JR., Wyckoff, NJ (US); Chin-Hung Terence Ma, Allendale, NJ (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/412,324

(22) Filed: Apr. 26, 2006

Related U.S. Application Data
(60) Provisional application No. 60/677,338, filed on May 4, 2005.

(51) Int. Cl. G06Q 40/00

(52) U.S. Cl. 705/35

(57) ABSTRACT

The present invention provides a method for providing a total return swap using a dealer hedging facility, the method comprising entering into the total return swap with an approved dealer participant, purchasing an underlying swap reference asset to hedge market risk, funding the purchase of the underlying swap reference asset from a repo counterparty or other short-term funding source committing capital to absorb potential losses from dealer participant and repo counterparty default, and establishing an SEC-registered broker to carry out the functions of the dealer hedging facility.

### CROSS-REFERENCE TO RELATED APPLICATIONS

This application claims priority from U.S. Provisional Patent Application No. 60/677,338, filed on May 4, 2005, the contents of which are incorporated herein by reference in their entirety.

### FIELD OF THE INVENTION

The invention broadly relates to a dealer hedging facility and more particularly to a method for providing total return swaps using a dealer hedging facility.

### BACKGROUND OF THE INVENTION

Dealers and banks often acquire the market exposure to particular securities to hedge short trading positions. As an example, when a dealer's customer requests the economics or exposure to a particular security, the dealer may sell short the exposure to the customer. To hedge the risk of loss resulting from the price fluctuation of the security, the dealer may either (i) purchase the security and hold it (“buy-&-hold”), or (ii) enter into an offsetting forward purchase agreement or “total return swap” with another dealer. Under strategy (i), the purchase of the security and the corresponding funding transaction increase the dealer's leverage and cost of capital. Under strategy (ii), the swap counterparty is likely another dealer with excess balance-sheet capacity or an offshore entity that is not subject to stringent U.S. regulations. The spread charged by the swap counterparty will not be any lower than the cost under the buy-&-hold strategy, as the swap counterparty would simply transfer its capital cost back to the dealer plus a profit margin. An offshore entity's pricing may be more competitive because of lenient regulations and lower capital requirements imposed by the local jurisdiction. However, this strategy is likely to attract regulatory scrutiny as the dealer's counterparty credit exposure, the underlying asset and the funding transaction are all located offshore. Furthermore, the dealer may need to warehouse the risk for a considerable period of time because of the lack of liquidity in the total return swap market, not to mention the cumbersome credit approval and legal documentation processes.

Dealers use total return swaps for various reasons including favorable accounting treatment. Current practice requires a dealer to find a willing counterparty with mutual credit approvals and capacity, acceptable underlying reference assets and collateral, and a competitive price. This process can frequently absorb valuable trading desk time and may require warehousing the risk for some interim period. Notwithstanding the inefficiency of the process, dealers still use total return swaps because of their inherent attractiveness for hedging without using balance sheet capacity.

From a broad perspective, the interrelationships among leverage, capital efficiency and balance sheet management continue as an important focus of rating agencies, securities analysts, regulators and investors. Unfortunately, the traditional GAAP balance sheet measurement of leverage has never been adequate for assessing market risk and capital adequacy. This deficiency in analysis was highlighted in highly respected research and studies on leverage published after Long Term Capital Management's failure. Still, few seem to be aware of this weakness and the potential of leverage for reducing market risk versus its more typical use.

If a customer of an SEC registered dealer wants the return on $500 million of corporate bonds through a swap, the dealer faces two basic hedging options to avoid market risk. The easiest and the cheapest route in terms of marginal debt cost is to buy the reference assets and position them with funding in the repo market. The trade and the funding at the applicable repo rate may be completed easily enough. However, while the specific marginal debt funding cost may be cheap, it alone understates the full funding cost because it does not take into account the cost of using some portion of the dealer's equity base which creates debt capacity. Generally, the cost of using the equity base is determined by the target return on equity after taxes and the target debt/equity ratio (i.e., the amount of equity allocated to a position relative to the amount of debt allocated). The weighted average of the debt and equity costs adjusted to a pretax basis is the real cost of funding a position.

By way of example, an 18% ROE after taxes is 30% pretax, assuming a tax rate of 40%. If the target debt to equity ratio is 96% debt and 4% equity and the repo rate is 2.7%, the weighted average cost is 3.79% (96% debt at a cost of 2.7% plus 4% equity at a cost of 30%), in accordance with GAAP. In addition, since performance ratios, such as returns on equity and assets, are based on GAAP, these measures are negatively affected by balance sheet positioning, even though the purpose of taking on the leverage is to eliminate market risk—a perverse result for risk mitigation. From a regulatory capital perspective, the impact becomes more perverse, because regular broker/dealers receive no regulatory capital relief for perfectly hedged customer trades. In fact, dealers must hold capital against both short and long positions as if the two positions were totally unrelated.

For banks, the accounting and regulatory conclusions are comparable in some aspects and different in others. U.S. banking regulators impose a risk-based capital requirement and a leverage capital requirement. The former applies different relative risk weights from 0% to 100% against four broad categories of assets and assesses a percentage capital requirement against the risk weighted assets. In contrast, the leverage capital requirement establishes a minimum Tier 1 equity percentage of average total assets, with no relief for low risk, high quality assets, even U.S. Treasuries. A minimum of 5% is required to be considered well-capitalized. Analysts and others use this and similar leverage measures under GAAP for assessing creditworthiness and earnings volatility. Unfortunately, few, if any, seem to make the important distinction or any adjustments based on the rationale for leverage. One reason is that leverage is most commonly employed in an attempt to increase shareholder returns. If such strategies increase market risk, the positions should be accounted for accordingly, without adjustment or offset. However, if leverage is used to fund a long cash position in order to hedge a matching short customer swap, that tactic eliminates market risk and should warrant different consideration. Unfortunately, GAAP accounting rules make no such provisions available for different treatment.

With respect to the regulatory risk-based capital requirement, it has typically exceeded both the leverage capital requirement and internal economic capital allocations and that higher capital charge has been an incentive for regulatory capital arbitrage. That incentive will likely be reduced as Basel II takes effect, when approved internal models which assess economic capital are permitted to determine regulatory risk based capital requirements. As Basel II attempts to match regulatory capital requirements to economic risk, risk-based capital requirements should decline in most cases. However, the leverage capital requirement will not change because it is determined by a percentage of average total assets and not the inherent risk of the assets. As a result, for some banking institutions, the leverage capital requirement may well establish a floor and could become the more restrictive of the two capital ratios. If that happens, the leverage capital requirement could constrain growth, limit efficient use of economic capital and distort the allocation of resources. While most foreign banks are not subject to a regulatory leverage capital requirement, they are affected by US regulatory standards indirectly through peer group comparisons. Therefore, they may be impacted similarly to U.S. banks.

In view of the above, there exists a need for a dealer hedging facility that encourages total return swap usage by improving the efficiency of executing swaps and reducing the transaction costs involved in the swaps.

Additionally, there exists a need for a dealer hedging facility that encourages the execution of a matching total return swap, which precludes the need to position assets on the balance sheet, thereby preserving dealer balance sheet capacity for new business and improving performance measures.

There further exists a need for a dealer hedging facility that assists in locating matching swaps in an efficient manner with preferred terms at the lowest cost available.

Additionally, there exists a need for a dealer hedging facility that allows participants to manage their market risks, resulting in a reduction of capital usage while improving counterparty credit quality and streamlining capital market operations.

### SUMMARY OF THE INVENTION

In view of the foregoing, it is an object of the present invention to provide a dealer hedging facility that encourages total return swap usage by improving the efficiency of executing swaps and reducing the transaction costs involved in the swaps.

It is another object of the present invention to provide a dealer hedging facility that encourages the execution of a matching total return swap, which precludes the need to position assets on the balance sheet, thereby preserving dealer balance sheet capacity for new business and improving performance measures.

It is a further object of the present invention to provide a dealer hedging facility that assists in locating matching swaps in an efficient manner with preferred terms at the lowest cost available.

It is an additional object of the present invention to provide a dealer hedging facility that allows participants to manage their market risks, resulting in a reduction of capital usage while improving counterparty credit quality and streamlining capital market operations.

One aspect of the invention involves a preferred method for providing a total return swap using a dealer hedging facility, the method comprising entering into the total return swap with an approved dealer participant, purchasing an underlying swap reference asset to hedge market risk, funding the purchase of the underlying swap reference asset from a repo counterparty or other short-term funding source, committing capital to absorb potential losses from dealer participant and repo counterparty default, and establishing an SEC-registered broker-dealer to carry out the functions of the dealer hedging facility. Additional steps may include: (1) charging the dealer participant an annual commitment fee and a spread over cost; (2) encouraging the dealer participant to provide market data for the dealer hedging facility; and/or (3) executing an ISDA Master Agreement with the dealer participant.

In the preferred method of the invention, the step of entering into a total return swap with an approved dealer involves entering into a master swap agreement between the dealer participant and the dealer hedging facility, wherein each trade between the parties is evidenced by a specific confirmation. The total return swap between the dealer participant and the dealer hedging facility may be terminated or assigned with mutual consent, or alternatively, may be for a predetermined duration.

In the preferred method of the invention, the step of funding the purchase of the reference asset may involve entering a repo arrangement with the repo counterparty, wherein the reference asset is within the capacity of a service provider and meets the parameters of market acceptance by the repo counterparty. The dealer hedging facility enters into the total return swap only when an asset matching the reference asset for the swap can be purchased from the open market. The reference asset preferably is selected from the group consisting of: U.S. Treasury obligations; U.S. Agency direct debt obligations; mortgage-backed pass-through securities issued by U.S. Agencies; selected asset-backed securities; and selected collateralized debt obligations. The dealer participant is entitled to receive any distributions on the reference asset and any increases in the market value of the reference asset. The dealer participant is responsible to pay to the dealer hedging facility any decrease in the market value of the reference asset and the actual cost of funding the reference asset for the total return swap plus a spread. The total return swap is subject to daily settlement on a net basis for the dealer participant. Unless other arrangements are made, the repo funding will be rolled over at maturity. The dealer hedging facility's borrowing levels will vary with the market value of the cash positions in the swap reference assets and will enable the dealer hedging facility to match cash requirements under its swap obligations.

The method may also involve a service provider that settles the purchase of the reference asset as intraday lender, wherein the service provider is repaid by the repo counterparty pursuant to a tri-party repo program. The reference asset may be held in a clearance account pursuant to the tri-party repo procedures. The service provider acts as a tri-party repo custodian of a collateral management system, wherein a repo transaction is collateralized utilizing the tri-party infrastructure of the service provider using assets held by the dealer hedging facility, the related specific swap trade confirms, and an assignment of rights under a swap agreement. The assigned rights provide the repo counterparty with a senior level claim against the dealer participant in the event of a dealer hedging facility default and a collateral shortfall. Before the repo counterparty delivers cash to the service provider, the service provider has a standard clearance exposure as the intraday lender settling the trade, but is secured by the reference asset purchased and the specific swap confirm. When the repo counterparty delivers the cash, the service provider assigns the collateral to an account of the repo counterparty. At repo maturity, the service provider unwinds the trade by repaying the repo counterparty and incurs unwind exposure as the intraday lender.

In accordance with the invention the dealer participant settles its margin call only once with the dealer hedging facility on a daily basis through a collateral management program of the service provider. The dealer hedging facility may be required to sell the asset into the open market to unwind the hedge if the dealer participant elects not to settle the swap in the reference asset. The dealer participant may achieve an improved leverage position since it is not required to finance the reference asset.

In accordance with the preferred method, the dealer hedging facility acts as a central principal between the dealer participant and the repo counterparty, wherein the dealer hedging facility enters into the total return swap with the dealer participant only if the repo counterparty accepts the reference asset as collateral. The dealer participant supplies a cash swap margin in an amount equal to repo margin requirements. The dealer hedging facility reserves the right to increase the swap margin if the dealer participant's counterparty rating falls below a predetermined level or grade. Additionally, the dealer participant pays the dealer hedging facility the actual cost of funding the reference asset for the swap plus a spread, and any depreciation in the reference asset underlying the swap. In return, the dealer hedging facility pays the dealer participant any dividend, interest, or other cash flows generated by the reference asset, and any capital appreciation in the reference asset.

The cost for using the dealer hedging facility of the invention is based on an annual commitment fee paid to the dealer hedging facility for its allocation of capital to the dealer participant. In addition, a swap rate to the dealer participant comprises a swap spread plus an actual cost of funding the asset, and the swap spread is based on an asset class and tenor of the reference asset. The dealer hedging facility may further comprise a risk management policy including procedures designed to reduce swap counterparty risk. The risk management policy includes position limits, adequate, one way, cash collateral swap margins based on repo market requirements, daily marking to market and settlements of swaps with provisions for netting by the dealer participant and mutual termination options. The market risk of the reference asset owned by the dealer hedging facility is transferred to the dealer participant, while the liquidity risk of the reference asset is assumed by the service provider pursuant to a tri-party repo program. The operational risk of the dealer hedging facility is assumed and managed by the service provider pursuant to a tri-party repo program.

Another aspect of the invention involves a method for providing a total return swap using a dealer hedging facility, method comprising entering into the total return swap with an approved dealer participant, purchasing an underlying swap reference asset to hedge market risk, funding the purchase of the underlying swap reference asset from a repo counterparty or other short-term funding source and committing capital to absorb potential losses from dealer participant and repo counterparty default, wherein the dealer participant is entitled to receive any distributions on the reference asset and any increases in the market value of the reference asset, and wherein the dealer participant is responsible to pay to the dealer hedging facility any decrease in the market value of the reference asset and the actual cost of funding the reference asset for the total return swap plus a spread.

A further aspect of the invention involves a method for providing a total return swap using a dealer hedging facility, comprising entering into the total return swap with an approved dealer participant; purchasing an underlying swap reference asset to hedge market risk; funding the purchase of the underlying swap reference asset from a repo counterparty or other short-term funding source and committing capital to absorb potential losses from dealer participant and repo counterparty default, wherein a service provider that acts as a tri-party repo custodian settles the purchase of the reference asset as an intraday lender, and wherein the service provider is repaid by the repo counterparty pursuant to a tri-party repo program.

An additional aspect of the invention involves a method for funding or capitalizing an operating company, the method comprising the steps of defining a plurality of tiers of risk, wherein each tier of risk is arranged in a predetermined sequence for absorbing a potential financial loss experienced by the operating company, defining a predetermined return on investment for each tier of risk, and defining a magnitude of an amount of capital to be raised for and designated for each tier of risk. The method may further comprise the steps of utilizing the capital raised for funding activities of the operating company, and raising capital from investors for each tier of risk, wherein the capital from each investor is designated for a specified tier of risk.

The above-identified method for funding or capitalizing an operating company may further comprise the step of defining a first tier of risk, which is first to absorb a financial loss experienced by the operating company, wherein a magnitude of the amount of capital raised and designated for the first tier of risk is determined by an analysis of the probability of and possible magnitude of losses to which the operating company is susceptible. The most probable losses to occur preferably do not exceed the amount of capital raised and designated for the first tier of risk. The method may further include the step of analyzing an operating plan of the operating company to determine a magnitude of the amount of capital raised and designated for each tier of risk. Further steps may comprise: (1) insuring all tiers of risk except the first tier of risk, each insured tier having a substantially lower inherent risk for experiencing losses than the first tier of risk; (2) insuring pre-selected tiers of risk against losses experienced by the operating company; and (3) offering an opportunity to an investor to invest in the operating company, whereby the investor is enabled to contribute funds to one or more tiers of risk.

### BRIEF DESCRIPTION OF THE DRAWINGS

FIG. 1 is a schematic diagram illustrating the mechanics of a preferred method for providing a total return swap using a dealer hedging facility, in accordance with the principles of the present invention; and

FIG. 2 is a schematic diagram illustrating the interplay between a dealer participant customer, a dealer participant and the dealer hedging facility of the invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Before starting a description of the Figures, some terms will now be defined.

Credit Derivative: A derivative designed to transfer credit risk from one party to another. By synthetically creating or eliminating credit exposures, credit derivatives allow institutions to more effectively manage credit risks. Credit derivatives take many forms, including credit default swaps, total return swaps and credit linked notes. Most credit derivatives entail two sources of credit exposure: one from the reference asset and the other from possible default by the counterparty to the transaction.

Total Return Swap: An agreement between two parties in which the parties swap periodic payment over the specified life of the agreement. The first party makes payments based upon the total return, namely, interest or dividends plus capital gains or losses of a specified reference asset, while the second party makes fixed or floating payments. Both parties' payments are based upon the same notional amount. The reference asset may comprise almost any asset, index or basket of assets.

Repurchase Agreement: A contract in which the seller of securities agrees to buy the securities back at a specified time and price. Repurchase agreements are also known as repos or buybacks.

Total return swaps are applicable for any investor seeking off-balance sheet alternatives. They are particularly attractive where the user does not wish to be actively involved in portfolio or rate risk management on a day-to-day basis. Additional advantages of total return swaps are that they may be highly customized and that they do not require an upfront premium. Furthermore, any underlying asset may be considered and the total return swap may be reversed at any time at the prevailing market rate. On the other hand, total return swaps require documentation from the International Swaps and Derivatives Association (ISDA), as well as a London InterBank Offering Rate (LIBOR) premium

A total return swap exchanges the total economic performance of a specified asset for another cash flow. In other words, payments between the parties to a total return swap are based upon changes in the market valuation of a specific credit instrument, irrespective of whether a credit event has occurred. Specifically, one counterparty (payer) pays to the other (receiver) the total return of a specified asset (reference obligation), wherein the total return comprises the sum of interest or dividends, and any change-in-value payments with respect to the reference obligation. The change-in-value payment is equal to any appreciation or depreciation in the market value of the reference obligation, as typically determined on the basis of a poll of reference dealers. A net depreciation in value results in a payment to the payer. In return, the receiver normally makes a regular floating payment of LIBOR plus a spread. A total return swap results in payments reflecting changes in the market valuation of a specified asset in the normal course of business.

When entering into a total return swap on an asset residing in its portfolio, the payer has effectively removed all economic exposure to the underlying asset. This risk transfer is effected without the need for a cash sale. Typically, the payer retains the servicing and voting rights to the underlying asset, although occasionally certain rights may be passed through to the receiver under the terms of the swap. The receiver has exposure to the underlying asset without the initial outlay required to purchase the asset. A key determinant of pricing of the “financing” spread on a total return swap is the cost to the payer of financing (and servicing) the reference obligation on its own balance sheet, which has in effect been lent to the receiver for the term of the transaction. Counterparties with high finding levels can make use of other lower-cost balance sheets through total return swaps, thereby facilitating investment in assets that diversify the portfolio of the user away from more affordable but riskier assets.

Because the maturity of a total return swap does not have to match the maturity of the underlying asset, the receiver in a swap with maturity less than that of the underlying asset may benefit from the positive carry associated with being able to roll forward short-term synthetic financing of a longer-term investment. The payer may benefit from being able to purchase protection for a limited period without having to liquidate the asset permanently. At the maturity of a total return swap whose term is less than that of the reference obligation, the payer essentially has the option to reinvest in that asset (by continuing to own it) or to sell it at the market price. At this time, the payer has no exposure to the market price since a lower price will lead to a higher payment by the receiver under the total return swap.

The purpose of the dealer hedging facility of the present invention is to offer a more efficient alternative for mitigating market risk, while enhancing liquidity and preserving balance sheet capacity. Principal activities of the dealer hedging facility may include, but are not limited to: (1) entering into total return swaps with approved dealers that may also be referred to herein as “dealer participants” or “participants”; (2) purchasing the underlying swap reference assets to hedge its market risk; (3) funding the purchase of the assets with repurchase agreements; (4) committing its own capital to absorb potential losses from operations and counterparty default; and (5) establishing an SEC-registered broker-dealer to carry out the functions of the dealer hedging facility. By way of example, each participant may be allocated $22 million of initial capital to support its swap positions, the notional total of which will be determined by a capital model accepted by the rating agencies. Participants may have to pay an annual commitment fee and a spread over the dealer hedging facility's cost of funds. In return, each participant may be expected to use the dealer hedging facility at levels that maximize the use of its allocated capital. To broaden the scope of the dealer hedging facility's product coverage, participants may be encouraged to provide market data for the dealer hedging facility to calculate the capital needed to support the credit exposure arising from other asset classes in conformity with the dealer hedging facility's capital allocation model.

In operation, the dealer hedging facility of the present invention may be involved in executing total return swaps with participants to pay the total return on assets and hedging that exposure with long positions in the swap reference assets with funding in the repo market. Various goals of the dealer hedging facility may include the enhancement of market liquidity, the encouragement of risk mitigation through lower cost of hedging, and the use of netting to conserve intraday liquidity needed for trade settlement. By increasing the efficiency of risk mitigation, the dealer hedging facility described herein will be compatible with public policy objectives to ensure the safety and soundness of financial markets. Different elements of the dealer hedging facility include, but are not limited to: (1) efficient risk mitigation; (2) increased capital efficiency; (3) better performance measures; (4) potential to offer similar benefits to customers (greater profitability); (5) new options for innovative financing and investment product development; and (6) netting for conserving intraday liquidity.

Although conventional dealers use total return swaps for various reasons including favorable accounting treatment, the dealer hedging facility of the present invention expands usage significantly by creating a more efficient process including more competitive costs. As described above, current practice requires a dealer to find a willing counterparty with mutual credit approvals and capacity, acceptable underlying reference assets and collateral, and a competitive price. However, dealers still use total return swaps because of their inherent attractiveness for hedging without using balance sheet capacity. The dealer hedging facility described herein will encourage swap usage by improving the efficiency of executing swaps and reducing transaction costs.

While total return swaps are subject to the regulatory risk-based capital requirement, they are outside of the scope of the leverage capital requirement because the notional amount of the reference assets for the contract is not a recorded balance sheet item. Rather, the net replacement value of swap contracts is recorded on the balance sheet. As a result of this accounting treatment, swaps are helpful for balance sheet management because they free up capital that might otherwise be needed to meet the leverage capital requirement. Swap cost is determined by the counterparty's required return on the funding leg of the swap, comprising an interest rate which is applied to the notional swap balance. This interest rate reflects the counterparty's borrowing costs, its capital allocation for the reference assets (which will likely be on its balance sheet), and its target return on equity. As a result, the swap rate quoted by most counterparties will almost always be greater than a participant's own on balance sheet marginal debt costs. However, if the participant includes an equity cost allocation, the comparison will depend on the specifics for each party.

The dealer hedging facility described herein includes a competitive advantage because its limited, low-risk business activity and efficient risk allocation among investors allow it to raise capital at a lower cost. With more competitive swap rates and a more efficient process, the dealer hedging facility encourages an expanded use of swaps, which may be employed for matched swaps, securities inventory, securitization alternative and other swaps. With respect to matched swaps, if a customer desires a long total return swap on specified assets immediately, the dealer hedging facility may accommodate and hedge the trade by using its balance sheet to buy in the reference assets. Additionally, the dealer hedging facility may execute the trade and have its desk begin making calls to approved counterparties for a matching swap, warehousing the risk of a naked short position in the interim. On the other hand, assuming the dealer hedging facility can buy in the assets, it may allow the participant to do a matched swap with no warehousing risk, and with a strong likelihood of a lower swap rate. The dealer hedging facility's reliability will help to improve dealer profitability and minimize risk since many dealers will prefer exposures through swaps to improve capital efficiency and performance measures.

The use of swaps for securities inventory may involve collateralized debt obligation (CDO) offerings and collateralized loan obligation (CLO) offerings in which the dealer hedging facility holds positions for later customer resale for cash or through a matched swap with the participant. This strategy works effectively within bank trading books and within dealer-owned BD Lites. A securitization alternative may involve the remote origination or purchase of receivables into the dealer hedging facility, combined with swaps to provide participants with the exposure to the receivables, wherein the participants may match the swaps with investors.

The dealer hedging facility of the present invention preferably is compatible with Basel II, which represents recommendations by bank supervisors and central bankers from the 13 countries making up the Basel Committee on banking supervision and international standards for measuring the adequacy of a bank's capital. Base II was created to promote greater consistency in the way banks and banking regulators approach risk management across national borders. As internal models are used more extensively, risk-based capital requirements will likely be reduced in most cases and therefore become easier to meet. However, the leverage capital requirement is expected to remain unchanged and therefore may have the potential to become more burdensome. The dealer hedging facility's participants will enjoy the benefit of capital efficiency under both regulatory requirements.

The dealer hedging facility described herein provides matched swaps that include a variety of participant benefits that are not provided when using conventional market-supplied swaps. Such benefits are implemented for risk mitigation, liquidity, and balance sheet management. Specifically, benefits of the dealer hedging facility of the present invention may include, but are not limited to: (1) lower swap rates for more efficient risk mitigation; (2) more efficient execution (increased confidence in completing a trade on a timely basis if the swap reference asset is available for purchase and repo); (3) potential for increased trading capacity with traditional repo counterparties; (4) access to a timely, reliable and consistent source of swaps, from a highly-rated, pre-approved counterparty; (5) enhanced liquidity for a broad range of asset exposures; (6) capital efficiency through greater use of swaps and their treatment for regulatory capital requirements and GAAP accounting purposes; (7) compatibility with an evolving regulatory framework; (8) conservation of intraday liquidity through increased use of netting; (9) little to no warehousing risk; and (10) compatibility with BD Lites owned by participants.

Trading with the dealer hedging facility may begin after the dealer hedging facility executes an ISDA Master Agreement with each participant. However, trading may be subject to eligibility criteria set by the dealer hedging facility. If eligibility criteria are not met on a continuing basis, the dealer hedging facility may reserve the right to terminate applicable participant's swaps and to sell the related reference assets. Participants may request exposures from a list of approved reference assets, each of which will have associated capital charges designed to maintain desired counterparty credit ratings. These reference assets should be: (1) available for purchase in the market; (2) acceptable collateral for repo counterparties; and (3) compatible with intraday credit guidelines.

While the intent is to accommodate participant needs, reference assets should be within the capacity of the service provider and meet the parameters of market acceptance by repo counterparties. Substantial diversity in reference assets is expected to arise from different investment objectives, customer bases, regulatory capital requirements, risk mitigation strategies, and other factors. At the outset, asset classes may be limited to U.S. Treasury obligations, U.S. Agency direct debt obligations, mortgage-backed pass-through securities issued by U.S. Agencies, selected asset-backed securities, and selected collateralized debt obligations. For other asset classes, participants may be asked to provide market data to analyze with the rating agencies in order to determine the capital requirement. These reference assets should be available for purchase and repo at the same time of the swap execution, so that the dealer hedging facility is always perfectly hedged.

To execute a transaction, the dealer hedging facility confirms with the participant a total return swap (under an ISDA Master Agreement) only when assets matching the reference assets for the swap can be purchased from the market. The purchase may be arranged by the same participant at an agreed price or executed by the dealer hedging facility at a more favorable price. The confirmation may include standard terms and may specify an applicable swap margin. In accordance with established settlement procedures, the service provider may settle the purchase as intraday lender, and later in the day be repaid by the repo counterparties pursuant to a tri-party repo program. The underlying assets may be held in a custody/clearance account pursuant to tri-party repo procedures.

Under the terms of the total return swap, the participant is entitled to receive any distributions on the underlying assets and any increases in the market value of the underlying assets. In return, the participant is responsible to pay to the dealer hedging facility any decrease in the market value of the assets and the actual cost of funding the reference asset for the particular swap plus a spread, which together will be sufficient to cover the dealer hedging facility's financing and operating expenses and to provide a return on capital invested in the dealer hedging facility. The swaps may be subject to daily settlement on a net basis for each participant. According to some embodiments, the repo funding may be rolled over at maturity, wherein the service provider may facilitate the process with intraday credit. The borrowing levels of the dealer hedging facility will vary with the market value of the cash positions in the swap reference assets, thereby enabling the dealer hedging facility to match cash requirements under its swap obligations. For example, an increase in asset values will require the dealer hedging facility to make payments under the swaps, which will be sourced from greater repo borrowings made possible with increased collateral values.

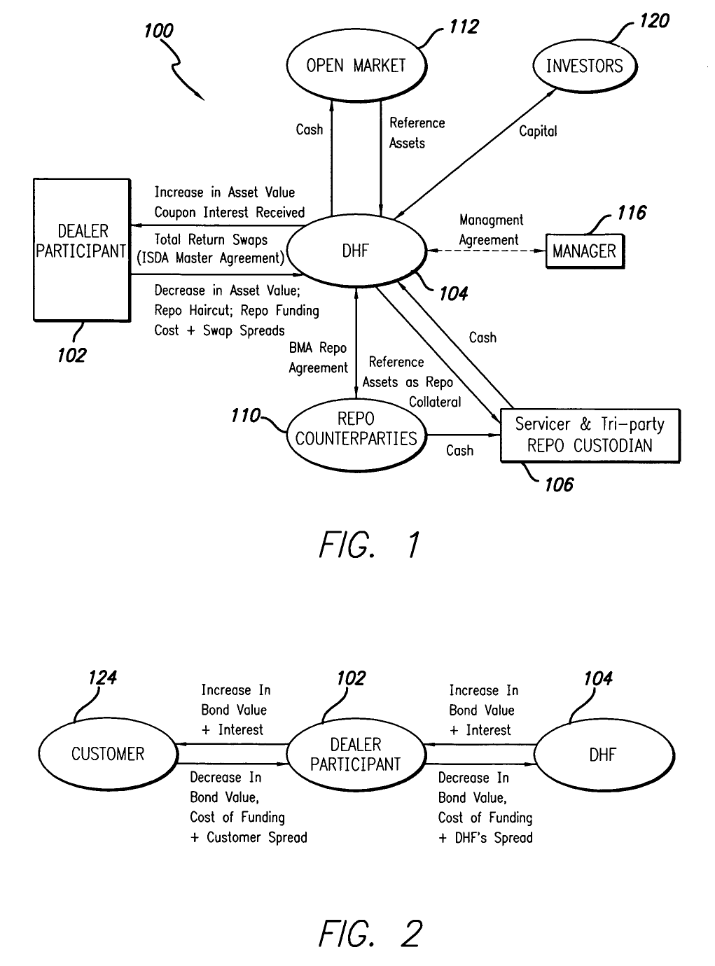

Referring to FIG. 1, a schematic is provided that illustrates the mechanics of a preferred method for providing a total return swap 100, in accordance with the principles of the invention. In particular, the total return swap 100 is between a dealer participant 102 and a dealer hedging facility 104. Target participants may comprise well-recognized financial institutions including banks and dealers. In accordance with the principles of the present invention, the preferred dealer hedging facility 104 enhances market liquidity for hedging and encourages risk mitigation through a lower cost of hedging. Additional transactional parties of the dealer hedging facility 104 may include a service provider 106 and repo counterparties 110. In particular, the service provider 106 may comprise a tri-party repo custodian of a sophisticated and comprehensive collateral management system. In operation, the dealer hedging facility 104 acts as the central principal between its participants 102 and various repo counterparties 110, thereby improving netting efficiency and strengthening counterparty credit quality.

In accordance with a “zero market risk” policy, the dealer hedging facility 104 may be required to sell the asset into the open market 112 to unwind the hedge if a participant 102 elects not to settle the swap in the underlying asset. An advisory group may act as a steering committee to oversee dealer hedging facility development and will form the dealer hedging facility 104, its Board of Directors (“Board”), and management 116 to conduct its business. Management 116 may consist of capital market veterans with a broad range of experience in trading, operations, systems, and data, in order to manage the daily operations of the dealer hedging facility 104. One or more investors 120 may provide the dealer hedging facility 104 with a source of capital.

Principal activities of the dealer hedging facility 104 include without limitation: (1) entering into total return swaps with approved dealer participants 102; (2) purchasing the underlying reference assets to hedge the market risk; (3) finding the assets with repurchase agreements; (4) committing its own capital to absorb losses due to participant or repo counterparty defaults; and (5) establishing an SEC-registered broker to carry out the functions of the dealer hedging facility. Securities forward transactions and total return swaps are alternative financial products that may be used to achieve the same result of hedging market risk, although they are subject to different market conventions. Securities forward transactions are typically governed under the Bond Market Association's Master Securities Forward Transaction Agreement, while swaps are generally governed under the International Swaps and Derivatives Association's ISDA Master Agreement. For illustrative purposes, a swap will be used as an example throughout this application.

Specific participant benefits of using the dealer hedging facility 104 of the invention include without limitation: (1) a lower cost of hedging; (2) enhanced market liquidity; (3) high credit quality; (4) standard legal documentation; (5) improved leverage position; and (6) and a reduced settlement risk. Regarding the lower cost of hedging, the total cost of entering total return swaps with the dealer hedging facility 104 is significantly less than the alternatives available to dealers today. Regarding enhanced market liquidity, the dealer hedging facility 104 is structured to enter into swaps with participants 102 on approved asset types so long as any of the approved repo counterparties 110 are willing to accept the underlying reference asset as collateral. To further enhance liquidity, participants may be encouraged to refer their existing repo counterparties to the dealer hedging facility 104 for early credit approval. Regarding high credit quality, the dealer hedging facility will preferably achieve the counterparty ratings of AAA by S&P and Aaa by Moody's, which are most likely better than participant's existing swap or repo counterparties.

Since the dealer hedging facility 104 is the common counterparty to all participants 102, the legal documentation (including the swap confirmations) may be standardized across all participants 102. This may further enhance the dealer hedging facility's leadership position in providing liquidity in the forward and total return swap markets. With respect to improved leverage position, as participants 102 no longer need to finance the reference assets, they may reserve their financing capacity with their own repo counterparties for other business opportunities and improve their leverage ratios. Regarding the reduced settlement risk, each participant 102 may settle its margin call only once with the dealer hedging facility 104 on a daily basis through a collateral management program of the service provider, thereby eliminating the existing cumbersome settlement traffic among multiple repo counterparties and improving the intra-day liquidity.

In particular, there is a master swap agreement between each dealer participant 102 and the dealer hedging facility 104, wherein each trade between the parties is evidenced by a specific confirmation. The payments due under each master swap agreement will be netted to one payment exchange daily between the dealer hedging facility 104 and each participant 102. Various advantages of the dealer hedging facility 104 include without limitation: (1) providing participants 104 with the opportunity for more efficient capital utilization; (2) simplifying the margining process, thus improving operations and clearing efficiencies; (3) allowing participants 102 to net credit exposure among multiple repo counterparties 100; and enabling participants 102 to expand trading capacity with their repo counterparties.

With further reference to FIG. 1, the repo transaction is collateralized utilizing the tri-party infrastructure of a service provider 106 using the assets held by the dealer hedging facility 104, the related specific swap trade confirms, and an assignment of certain rights under the swap agreement. The intent of the dealer hedging facility 104 is that these assigned rights will provide a repo counterparty 110 with a senior level claim against the participant 102 in the event of a dealer hedging facility default and a collateral shortfall. Additionally, dealer participants 102 will supply cash swap margin in an amount equal to the collateral requirement on the funding side (e.g., repo margin requirements). As set forth above, each participant 102 may settle its margin call only once per day through a collateral management program of the service provider, thereby eliminating existing cumbersome settlement traffic among multiple repo counterparties 110. The dealer hedging facility 104 may reserve the right to increase the swap margin if a participant's counterparty rating falls below a predetermined level or grade.

The participant 102 will pay to the dealer hedging facility 104 the actual cost of funding the reference asset for the particular swap plus a spread and will be subject to daily re-margining. In agreement with the participant 102, financing may be provided by the dealer hedging facility 104 through its own resources. In this event, the participant 102 may or may not be advised as to the name of the repo counterparty 110 or the actual rate. Alternatively, given the nature of the collateral, the participant 102 may wish to arrange financing as referral agent for the dealer hedging facility 104. In this event, the swap spread will be added to the actual repo rate. According to some embodiments, term repo may also be accommodated. In addition, the participant 102 will pay to the dealer hedging facility 104 any depreciation in the reference assets underlying its swaps, and the dealer hedging facility 104 will repay repo borrowings accordingly because of the reduced market values.

The dealer hedging facility 104 will pay to the participant 102 any dividend, interest, or other cash flows generated by the assets held as received and it will pay any capital appreciation in the reference assets. All amounts due between a participant 102 and the dealer hedging facility 104 will be netted to one exchange. Excess cash collateral will be transferred and released as necessary in accordance with market convention. The infrastructure of the dealer hedging facility 104 may be designed to be compatible with a collateral management program of the service provider. The tri-party repo program will provide for settling market purchases of assets by the dealer hedging facility 104. Before the repo counterparty 110 delivers cash to the service provider 106, the service provider 106 will have its standard clearance exposure, as the intraday lender settling the trade, but will be secured by the assets purchased and the specific swap confirm.

When the repo counterparty 110 delivers its cash, the service provider 106 will assign the collateral to the account of the repo counterparty 110 under the tri-party program. At repo maturity, the service provider 106 will unwind the trade by repaying the repo counterparty 110 and again will incur its unwind exposure as intraday lender, while being protected by the requisite collateral package. The process generally repeats itself by the end of the day. Similar to dealer funding arrangements, the dealer hedging facility 104 will be treated by the service provider 106 as a traditional repo borrower seeking funding in the repo market.

Referring to FIG. 2, a dealer participant 102 acquires market exposure to particular securities for various reasons such as hedging a short trading position with an outright purchase or covering a short sale with a reverse repurchase agreement. For example, a dealer's customer 124 is planning to repurchase its bonds in the open market. The customer 124 expects the price of the bonds to rise and wishes to hedge the risk on the repurchase. The customer 124 may buy back the bonds now in the open market to eliminate the risk of rising prices in the future. However, this hedging strategy may deprive the customer 124 of the cash it may need for other business purposes today. To preserve liquidity, the customer 124 may alternatively enter into a total return swap with a dealer to achieve the same objective. The customer 124 essentially acquires all the economic benefits along with the downside potentials of bond ownership without the need to finance the repurchase upfront. Conversely, the dealer participant 102 becomes seller of the bond as well as provider of financing for the “synthetic bond repurchase” by the customer 124. The application of total return swaps covers a wide range of financial assets, including fixed income securities and equity indices. To hedge the risk of loss due to price movement of the underlying asset, the participant 102 must take a long position in the security by either (i) purchasing and holding the bonds (what the customer could have done), or (ii) entering into an offsetting total return swap with another dealer.

By employing a “buy and hold” hedging strategy, the dealer participant 102 may purchase the bonds and hold it for as long as the swap with the customer is outstanding. Typically, the participant 102 finances the purchase of the bonds by entering into a repo agreement (i.e., borrowing short term with the bonds as collateral) with a third party. When the bond value goes up, the participant 102 receives excess margin from the repo counterparty and then passes along all the economic benefits, namely, the increase in bond value and interest received, if any, to the customer. Conversely, the participant 102 may recover from the customer any decline in bond value along with the repo funding cost and a spread. Keeping the spread as profit, the participant 102 hands over the remaining proceeds to the repo counterparty to cover the margin deficit and the interest cost on the repo agreement. Except for the risk of customer or repo counterparty default, the dealer's economic risks on the swap are “perfectly” hedged with the ownership of the underlying asset. The disadvantage of this strategy is that asset ownership and the corresponding funding transaction consume the dealer's capital, and the associated cost of capital is prohibitively high.

Under an offsetting swap hedging strategy, the participant 102 is essentially seeking another swap counterparty to replicate or to offset the risk of the swap it has sold to the customer 124. The swap counterparty is likely another dealer participant with excess balance sheet capacity or an offshore entity subject to less stringent regulations and capital constraints. The total cost associated with an offsetting swap will not be any lower than the cost under the buy-and-hold strategy, as the swap counterparty would simply transfer its capital cost back to the dealer plus a “dealer spread”. If the dealer spread charged by the swap counterparty is larger than the customer spread, the participant 102 may actually suffer a loss as the cost of hedging exceeds the customer profit.

With further reference to FIG. 2, the participant 102 enters into an offsetting swap with the dealer hedging facility 104, which simultaneously purchases the underlying bonds in the open market, and finances the purchase in the repo market with the bonds as collateral. However, unlike conventional dealers such as dealer participant 102, the dealer hedging facility 104 includes a spread that is expected to be significantly lower than that charged by another dealer. The lower spread is the result of the dealer hedging facility's capital and operational structure being designed for a narrowly focused objective. The dealer hedging facility 104 may commit a fixed amount of capital for each participant 102 and will stand ready to provide the participants 102 with liquidity, which currently does not exist in the total return swap market.

As compared to the buy & hold strategy discussed above, the dealer hedging facility's low-cost structure will enable its participants 102 to achieve the same economic objective at lower cost. Although the market for total return swaps has existed for a number of years, its liquidity still remains in its infancy largely due to the non-standardized nature of the market. Dealer participants and end users often consume a lengthy period of time to identify counterparties, negotiate transaction details and legal documentation, and obtain credit approval. Conversely, the dealer hedging facility 104 stands ready to enter into swaps indexed to pre-approved asset types with participants 102 upon request.

According to the invention, each participant 102 will be allocated certain amount of the dealer hedging facility's 104 capital to support the participant's 102 swap positions. The amount of capital consumed by each swap will mainly depend on the swap tenor, the notional size and the underlying asset type. Once admitted as a participant 102, no further credit approval is required for individual transactions so long as the committed capital has not been fully utilized and other credit standards remain satisfied. As participants 102 approach their maximum capital usage, they may request an increase in capital allocation, subject to the approval of the dealer hedging facility's 104 credit committee. However, capital will not be committed to those participants who do not pay for the commitment fee. The dealer hedging facility 104 will execute trades with “non-paying” customers only if excess capital is available at execution, and the dealer hedging facility 104 will recover its capital cost through a wider swap spread.

According to the invention, the underlying assets may be pre-approved, and the corresponding capital usage may be predetermined pursuant to a risk management policy that is updated as required by the rating agencies. As soon as an approved repo counterparty 110 is identified, the dealer hedging facility 104 may immediately acquire the asset and simultaneously enter into the swap with the participant 102. Pre-approved asset types may include U.S. Treasury obligations, U.S. Agency direct debt obligations, mortgage-backed pass-through securities issued by U.S. Agencies, asset-backed (credit cards and home equity) securities, and collateralized debt obligations. To broaden product coverage, participants 102 may be encouraged to provide market data relating to the particular asset types they wish to include as approved underlying assets.

According to the invention, if a dealer participant 102 no longer needs to hedge an exposure on a particular asset, it may have the right to terminate the applicable swap at any time. Likewise, the dealer hedging facility 104 may terminate at any time, but would generally not do so if the participant 102 is in compliance with policies and procedures. Alternatively, the contract between a participant 102 and the dealer hedging facility may be for a predetermined duration (i.e., a term repo). Upon a termination, the swap contract may provide for final settlement in cash or by delivery of the underlying asset. If the participant 102 elects not to settle the swap in the underlying asset, the dealer hedging facility 104 may be required to sell the asset into the open market 112 to unwind the hedge, in accordance with the “zero market risk” policy. The selling price of the underlying asset will in part determine the last payment exchange under the swap agreement. In this manner, the dealer hedging facility 104 is protected irrespective of the asset purchasing party.

The probability that a participant 102 fails to make a required payment under its master swap agreement is very low given the anticipated credit quality of participants and daily net settlements. A participant default under the master swap agreement does not necessarily give rise to dealer hedging facility exposure, since this could mean only a failure to meet a swap margin call. Nevertheless, a default may precipitate the sale of all related underlying assets under the participant's master swap agreement. Netting will allow the dealer hedging facility 104 to take positions that are sold at market value and apply cash from excess margin to cover positions sold at a loss, if any, thereby further decreasing the possibility of an exposure. The actual result will depend on the assets, the available margin, market volatility and other factors. Therefore, even with a default, the final close-out may not require a payment from the defaulting participant 102. However, in the case of a collateral deficiency after a default, the dealer hedging facility 104 may be responsible to use its capital to make an immediate payment to the repo counterparties 110 up to an established maximum amount.

In the case of a term repo, a special provision may be designed to allow immediate termination of the transaction at market value. Establishing a maximum payment is designed to permit ongoing operation of the dealer hedging facility 104 without disruption and to assure continued solvency. The maximum payment represents the first loss credit support provided by the dealer hedging facility 104, which will then make a claim against the participant 102 to recover its loss and the deficiency of the repo counterparty 110, if any. The swap has senior level creditors' standing against the participant 102. To the extent that the collateral deficiency exceeds the maximum payment, the settlement proceeds received after adjudication of all claims will be allocated between the dealer hedging facility 104 and the repo counterparties 110 in proportion to their respective losses.

For example, given a $25 million shortfall and an established $15 million maximum payment limit, the dealer hedging facility 104 would pay out $15 million (60% of the shortfall) to the repo counterparties 110. The dealer hedging facility 104 would then litigate against the defaulting dealer participant 102 for the shortfall. The swap agreement will provide for a senior level claim against the participant 102 for the shortfall of $25 million. Proceeds received upon liquidation will be allocated on a pari passu basis (i.e., on equal step) to the repo counterparties 110 and the dealer hedging facility 104 in proportion to the losses and payments between the two parties. If $10 million is recovered, the dealer hedging facility 104 would retain 60% of that amount or $6 million and allocate 40% or $4 million to the repo counterparties 110. Therefore, the dealer hedging facility 104 would incur a net loss of $9 million (the initial $15 million payment less the $6 million recovery), and the repo counterparties 110 would have received a total of $19 million (the initial $15 million dealer hedging facility payment plus the $4 million recovery) against the $25 million shortfall, incurring a net loss of $6 million. The net loss of the participant 102 would have been $15 million ($25 million less $10 million recovered) plus litigation expenses, were it not for the credit support of the dealer hedging facility 104. Given participant credit quality, the minimum margin available and daily re-margining, the risk exposure is very low. In the unlikely event of a loss, a senior claim against a regulated financial market participant 102 should have a reasonably good possibility of payment.

The initial capital allocated to each participant 102 will support positions in the underlying assets positioned to hedge its related swaps. Based on a capital allocation model accepted by the rating agencies for use in another business application, the allocated capital will support certain aggregate asset positions and corresponding swap notional amounts. For any fixed amount of capital, these aggregate positions will vary by the asset classes and tenors used. Each participant 102 will be expected to maximize the use of its allocated capital. By way of example, if a participant 102 were to allocate its $22 million capital availability equally to support positions in 1-, 2-, 5-, 10- and 30-year U.S. Agency mortgage-backed securities, the model of the dealer hedging facility 104 (which will be subject to the rating agencies' final acceptance) would permit maximum swap notional amounts of approximately $5.4 billion.

For other asset classes, dealer participants 102 will be required to provide relevant market data which will be used by the dealer hedging facility 104 to assess capital requirements to support those credit exposures. Virtually any asset class may be the swap reference index as long as financing is available, but excessive concentrations in high risk asset classes will be closely monitored and subject to pre-determined sub-limits. Required capital will be determined by a capital model approved by the rating agencies. Some limits may be modified based upon experience; however a cautious approach may be necessary to comply with the standards set by the rating agencies, particularly in the early stages of operations.

The cost for using the dealer hedging facility of the present invention may be based on an annual commitment fee paid to the dealer hedging facility 104 for its allocation of capital to a participant 102. This fee may provide the participant 102 with the right to use the dealer hedging facility 104, including the capital allocation. A swap spread expressed as a basis point spread may be added to the actual cost incurred to fund the assets underlying a participant's swaps. The swap rate to the participant 102 comprises the swap spread plus the actual cost of funding the asset (e.g., the repo rate). The swap spread is based on the asset class and tenor of the underlying swap reference assets.

Swap collateral margins may be the same as haircuts on the funding side, except in the event of credit deterioration where margins may be raised to higher levels and/or the size of the outstanding swap portfolio may have to be reduced. There may be no tenor limit to the swaps provided that each swap has a mutual termination option at any time. As a matter of policy, the dealer hedging facility 104 will not terminate swaps of an approved participant 102 in good standing. Initially, participants 102 will have the flexibility to use overnight or term repo. A medium term note program may be established depending on participant interest.

The dealer hedging facility 104 may include a planned capitalization that complies with NASD/SEC rules for regulatory capital requirements. Additionally, the dealer hedging facility 104 may be subject to higher capital requirements in order to maintain a “AAA” rating. An advisory group may act as a steering committee to form the dealer hedging facility 104, elect its Board of Directors, hire suitable management 116 to conduct its business, and oversee continued dealer hedging facility development. As the dealer hedging facility 104 is established, the Board will set policies and procedures for the conduct of the business. In the course of its responsibilities, the Board may contract with a service provider 106 to provide most infrastructure needs. These services may include custody, clearing, collateral management, tri-party financing and other related functions. Management 116 may establish prudential standards for the conduct of business to assure the dealer hedging facility 104 is operated in a safe and sound manner. Standards may be developed and subject to approval by the Board.

For the reasons set forth above, the dealer hedging facility 104 of the present invention may comprise a valued intermediary in the derivatives marketplace by providing a new dimension of liquidity to the market and creating new capital efficiency options. In addition, dealer hedging facility 104 may reduce the costs of certain derivatives trades below existing market levels and increase the efficiency of trade execution and settlement. Moreover, it is envisioned that the above goals are accomplished with a high level of safety and soundness.

Turning now to risk management practices, the major risks faced by the dealer hedging facility 104 will likely include counterparty credit risk, market risk, interest rate risk, funding risk, operational risk and other risks. Counterparty credit risk results from potential default by a participant 102 or repo counterparty 110. This is the primary risk assumed by the dealer hedging facility 104. It may be addressed by stringent underwriting standards for admission as a participant 102 or a repo counterparty 110 and through the establishment of credit limits. These responsibilities will be undertaken by the service provider 106 as intraday lender. Counterparty risk may arise through the failure of a participant 102 to meet a swap obligation (e.g., to cover a severe decline in the value of swap reference assets). Additionally, an increase in the value of reference assets may also subject the dealer hedging facility 104 to credit risk if the repo counterparty 110 fails to return excess collateral. The procedures designed to reduce swap counterparty risk include without limitation: (1) establishing position limits; (2) establishing adequate, one way, cash collateral swap margins based on repo market requirements; (3) establishing daily marking to market and settlements of swaps with provisions for netting by the participant 102; and (4) establishing mutual termination options.

Swap margins may be determined by haircuts on the funding side, for example by repo counterparties 110 and the service provider 106 as the intraday lender. The dealer hedging facility 104 may reserve the right to increase swap margins in the event that a participant's counterparty credit rating falls below a predetermtined level or grade. Swap margins may be settled daily since conventional repo markets require daily settlement of margin. An advantage of daily settlements is that the replacement cost of the swap contract (which is the basis for determining balance sheet carrying values) is fully collateralized. The participant benefits from concentrating more swap business with one counterparty because of greater potential for netting, which conserves liquidity. As stated, the dealer hedging facility 104 may: (1) impose collateral margin based on market requirements; (2) mark positions to market daily, if not more frequently when warranted; and (3) settle margin daily, netting exposures by counterparty. In this manner, the procedures emulate the critical risk mitigation techniques of futures and options clearing houses.

In accordance with the invention, the market risk of the reference assets owned by the dealer hedging facility 104 will be allocated to participants 104. Interest rate risk never arises because the participant swap rate is structured at a spread above actual funding rates. Funding risk will not exist if the dealer hedging facility 104 waits until a repo counterparty 110 has been identified before entering into a swap agreement with a participant 102. Liquidity risk will be assumed by the service provider 106 in the course of the customary obligations of its tri-party repo program as intraday lender.

Operational risk for the dealer hedging facility 104 may be assumed and managed by the service provider 106 pursuant to a tri-party repo program. Various functions may include all phases of collateral and cash management, custody, clearing, settlement, netting procedures, and other functions. Further elements of operational risk for the dealer hedging facility 104 may include pricing, deal capturing, and system failure. The dealer hedging facility 104 will dedicate part of its capital to cover these risks. Additional operational risks for the dealer hedging facility 104 include legal and compliance risks. These risks may be assumed on a day-to-day basis by the service provider 106 and manager 116 in the course of their general business activities or incidental to the service provider's tri-party repo program.

In accordance with the principles of the invention, a method for funding or capitalizing an operating company for the dealer hedging facility will now be described. Initially, the method comprises defining a plurality of tiers of risk, wherein each tier of risk is arranged in a predetermined sequence for absorbing a potential financial loss experienced by the operating company. The next steps involves defining a predetermined return on investment for each tier of risk, and defining a magnitude of an amount of capital to be raised and designated for each tier of risk. The method may further comprise the steps of utilizing the capital raised for funding activities of the operating company, and raising capital from investors for each tier of risk, wherein the capital from each investor is designated for a specified tier of risk.

The method for funding or capitalizing an operating company may further comprise defining a first tier of risk that is first to absorb a financial loss experienced by the operating company. A magnitude of the amount of capital raised and designated for the first tier of risk may be determined by an analysis of the probability of and possible magnitude of losses to which the operating company is susceptible. The most probable losses to occur preferably do not exceed the amount of capital raised and designated for the first tier of risk. Additional method steps may include: (1) analyzing an operating plan of the operating company to determine a magnitude of the amount of capital raised and designated for each tier of risk; (2) insuring all tiers of risk except the first tier of risk, each insured tier having a substantially lower inherent risk for experiencing losses than the first tier of risk; (3) insuring pre-selected tiers of risk against losses experienced by the operating company; and (4) offering an opportunity to an investor to invest in the operating company, whereby the investor is enabled to contribute funds to one or more tiers of risk.

Thus, it is seen that a dealer hedging facility is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

1. A method for providing a total return swap using a dealer hedging facility, the method comprising the steps of:
entering into the total return swap with an approved dealer participant;
purchasing an underlying swap reference asset to hedge market risk;
finding the purchase of the underlying swap reference asset from a repo counterparty or other short-term finding source;
committing capital to absorb potential losses from dealer participant and repo counterparty default; and
establishing an operating company to carry out the functions of the dealer hedging facility.

2. The method of claim 1, further comprising the step of charging the dealer participant an annual commitment fee and a spread over cost.

3. The method of claim 1, further comprising the step of encouraging the dealer participant to provide market data for the dealer hedging facility.

4. The method of claim 1, wherein the step of funding the purchase of the reference asset involves entering a repo arrangement with the repo counterparty.

5. The method of claim 1, wherein a class of the reference asset is limited to U.S. Treasury obligations, U.S. Agency direct debt obligations, mortgage-backed pass-through securities issued by U.S. Agencies, asset-backed securities, and collateralized debt obligations.

6. The method of claim 1, wherein the dealer hedging facility enters into the total return swap only when an asset matching the reference asset for the swap can be purchased simultaneously from the open market.

7. The method of claim 1, wherein the dealer participant is entitled to receive any distributions on the reference asset and any increases in the market value of the reference asset.

8. The method of claim 1, wherein the dealer participant is responsible to pay to the dealer hedging facility any decrease in the market value of the reference asset and the actual cost of funding the reference asset for the total return swap plus a spread.

9. The method of claim 1, wherein the total return swap is subject to daily settlement on a net basis for the dealer participant.

10. The method of claim 1, wherein the dealer participant settles its margin call only once with the dealer hedging facility on a daily basis through a collateral management program of the service provider.

11. The method of claim 1, wherein the dealer hedging facility is required to sell the asset into the open market to unwind the hedge if the dealer participant elects not to settle the swap in the reference asset.

12. The method of claim 1, wherein the dealer participant achieves an improved leverage position since it is not required to finance the reference asset.

13. The method of claim 1, wherein the step of entering into a total return swap with an approved dealer involves entering into a master swap agreement between the dealer participant and the dealer hedging facility, wherein each trade between the parties is evidenced by a specific confirmation.

14. The method of claim 1, wherein:
the dealer hedging facility acts as a central principal between the dealer participant and the repo counterparty; and
the dealer hedging facility enters into the total return swap with the dealer participant only if the repo counterparty accepts the reference asset as collateral.

15. The method of claim 1, further comprising a service provider that acts as a tri-party repo custodian of a collateral management system, wherein a repo transaction is collateralized utilizing a tri-party infrastructure of the service provider using assets held by the dealer hedging facility, the related specific swap trade confirms, and an assignment of rights under a swap agreement.

16. The method of claim 1, wherein the dealer participant supplies a cash swap margin in an amount equal to repo margin requirements.

17. The method of claim 1, wherein:
the dealer participant pays the dealer hedging facility the actual cost of funding the reference asset for the swap plus a spread; and
the dealer participant pays the dealer hedging facility any depreciation in the reference asset underlying the swap.

18. The method of claim 1, wherein:
the dealer hedging facility pays the dealer participant any dividend, interest, or other cash flows generated by the reference asset; and
the dealer hedging facility pays any capital appreciation in the reference asset.

19. The method of claim 1, wherein:
the reference asset is pre-approved; and
a corresponding capital usage is predetermined pursuant to a risk management policy.

20. The method of claim 19, wherein the pre-approved asset is selected from the group consisting of: U.S. Treasury obligations; U.S. Agency direct debt obligations; mortgage-backed pass-through securities issued by U.S. Agencies; asset-backed securities; and collateralized debt obligations.

21. The method of claim 1, wherein the total return swap between the dealer participant and the dealer hedging facility may be terminated or assigned with mutual consent.

22. The method of claim 1, wherein the total return swap between the dealer participant and the dealer hedging facility is for a predetermined duration.

23. The method of claim 1, wherein a cost for using the dealer hedging facility is based on an annual commitment fee paid to the dealer hedging facility for its allocation of capital to the dealer participant.

24. The method of claim 1, wherein:
a swap rate to the dealer participant comprises a swap spread plus an actual cost of funding the asset; and
the swap spread is based on an asset class and tenor of the reference asset.

25. The method of claim 1, wherein the dealer hedging facility includes a planned capitalization that complies with NASD/SEC rules for regulatory capital requirements.

26. The method of claim 1, wherein the dealer hedging facility is compatible with Basel II.

27. The method of claim 1, further comprising a risk management policy established by the dealer hedging facility including procedures designed to reduce swap counterparty risk.

28. The method of claim 27, wherein the risk management policy includes position limits, adequate, one way, cash collateral swap margins based on repo market requirements, daily marking to market and settlements of swaps with provisions for netting by the participant and mutual termination options.

28. The method of claim 1, wherein a market risk of the reference asset owned by the dealer hedging facility is transferred to the dealer participant.

29. A method for providing a total return swap using a dealer hedging facility, the method comprising the steps of:
entering into the total return swap with an approved dealer participant;
purchasing an underlying swap reference asset to hedge market risk;
funding the purchase of the underlying swap reference asset from a repo counterparty or other short-term funding source; and
committing capital to absorb potential losses from dealer participant and repo counterparty default;
wherein a service provider that acts as a tri-party repo custodian settles the purchase of the reference asset as an intraday lender;
wherein the service provider is repaid by the repo counterparty pursuant to a tri-party repo program.

30. The method of claim 29, wherein the reference asset is held in a clearance account pursuant to the tri-party repo procedures.

31. The method of claim 30, wherein a repo transaction is collateralized utilizing a tri-party infrastructure of the service provider using assets held by the dealer hedging facility, the related specific swap trade confirms, and an assignment of rights under a swap agreement.

32. The method of claim 31, wherein the assigned rights provide the repo counterparty with a senior level claim against the dealer participant in the event of a dealer hedging facility default and a collateral shortfall.

33. The method of claim 31, wherein before the repo counterparty delivers cash to the service provider, the service provider has a standard clearance exposure as the intraday lender settling the trade, but is secured by the reference asset purchased and the specific swap confirm.

34. The method of claim 33, wherein when the repo counterparty delivers the cash, the service provider assigns the collateral to an account of the repo counterparty.

35. The method of claim 34, wherein at repo maturity, the service provider unwinds the trade by repaying the repo counterparty and incurs unwind exposure as the intraday lender.

36. The method of claim 29, wherein a liquidity risk of the reference asset is assumed by the service provider pursuant to the tri-party repo program.

37. The method of claim 29, wherein an operational risk of the dealer hedging facility is assumed and managed by the service provider pursuant to the tri-party repo program.

38. A method for funding or capitalizing an operating company, the method comprising the steps of:
defining a plurality of tiers of risk, wherein each tier of risk is arranged in a predetermined sequence for absorbing a potential financial loss experienced by the operating company;
defining a predetermined return on investment for each tier of risk; and
defining a magnitude of an amount of capital to be raised for and designated for each tier of risk.

39. The method of claim 38, further comprising the step of utilizing the capital raised for funding activities of the operating company.

40. The method of claim 38, further comprising the step of raising capital from investors for each tier of risk, wherein the capital from each investor is designated for a specified tier of risk.

41. The method of claim 38, further comprising the step of defining a first tier of risk, which is first to absorb a financial loss experienced by the operating company, wherein a magnitude of the amount of capital raised and designated for the first tier of risk is determined by an analysis of the probability of and possible magnitude of losses to which the operating company is susceptible.

42. The method of claim 41, wherein the most probable losses to occur do not exceed the amount of capital raised for and designated for the first tier of risk.

43. The method of claim 41, further comprising the step of analyzing an operating plan of the operating company to determine a magnitude of the amount of capital raised and designated for each tier of risk.

44. The method of claim 41, further comprising the step of insuring all tiers of risk except the first tier of risk, each insured tier having a substantially lower inherent risk for experiencing losses than the first tier of risk.

45. The method of claim 38, further comprising the step of insuring pre-selected tiers of risk against losses experienced by the operating company.

46. The method of claim 38, further comprising the step of offering an opportunity to an investor to invest in the operating company, whereby the investor is enabled to contribute funds to one or more tiers of risk.

47. The method of claim 38, wherein the dealer hedging facility includes a planned capitalization that complies with NASD/SEC rules for regulatory capital requirements.

48. A method for providing a total return swap using a dealer hedging facility, the method comprising the steps of:
entering into the total return swap with an approved dealer participant;
purchasing an underlying swap reference asset to hedge market risk;
funding the purchase of the underlying swap reference asset from a repo counterparty or other short-term funding source;
committing capital to absorb potential losses from dealer participant and repo counterparty default; and
establishing an operating company to carry out various functions of the dealer hedging facility, the functions including: defining a plurality of tiers of risk, wherein each tier of risk being arranged in a predetermined sequence for absorbing a potential financial loss experienced by the operating company; defining a predetermined return on investment for each tier of risk; and defining a magnitude of an amount of capital to be raised for and designated for each tier of risk;
wherein a service provider that acts as a tri-party repo custodian settles the purchase of the reference asset as an intraday lender;
wherein the service provider is repaid by the repo counterparty pursuant to a tri-party repo program.
